(19) United States
(12) Patent Application Publication
(10) Pub. No.: US 2022/0223963 A1
(43) Pub. Date: Jul. 14, 2022

(54) BATTERY HOUSING AND BATTERY COMPRISING SAME

(71) Applicant: Clarios Germany GmbH & Co. KG, Hannover (DE)

(72) Inventor: Michael Koop, Bielefeld (DE)

(21) Appl. No.: 17/610,032

(22) PCT Filed: May 7, 2020
(86) PCT No.: PCT/EP2020/062642

§ 371 Date: Nov. 9, 2021

(30) Foreign Application Priority Data
May 10, 2019 (DE) 10 2019 112 219.8

(51) Int. Cl. H01M 50/242; H01M 50/24; H01M 50/207

(52) U.S. Cl. CPC H01M 50/242; H01M 50/249; H01M 50/207; H01M 50/24

(57) ABSTRACT

The present invention relates to a battery housing for a vehicle battery, in particular for a truck battery, the battery housing having the following: a lower housing part for receiving a multiplicity of electrochemical cells, the lower housing part enclosing an interior space, and a housing cover, which can be connected or is connected to the lower housing part in such a way that the interior space is sealed of and closed off from an external environment, wherein the lower housing part has a base element, and wherein a multiplicity of projections are arranged in a pattern on at least one area of the base element.

The present invention relates to a battery housing for a vehicle battery, in particular for a truck battery, and to a battery for a vehicle, in particular for a truck, with such a housing.

Conventionally, in truck batteries a multiplicity of cell stacks forming electrochemical cells are bonded to a lower wall (base element) of the battery housing by means of an adhesive. For this purpose, usually the entire area of the lower wall is covered with the adhesive and the cell stacks are placed on top in order to improve the vibration resistance of the truck battery during operation. However, with such conventional truck batteries the problem arises that, due to the forces and vibrations occurring during operation (while the truck is driving), although the adhesive adheres well to the cell stacks, it becomes detached from the lower wall, which has the effect that the cell stacks and cell connectors can be damaged and poor results are obtained in battery vibration resistance tests.

The present application is therefore based on the object of providing an improved battery housing for vehicle batteries which does not have the disadvantages of the prior art and which is quick, easy and inexpensive to manufacture and which improves the vibration resistance of the battery in use or in operation.

The object on which the invention is based is achieved by means of the subjects of the independent patent claims 1 and 16. Advantageous developments are specified in the dependent claims.

Accordingly, a battery housing for a vehicle battery, in particular for a truck battery, is specified, which has the following: a lower housing part for receiving a multiplicity of electrochemical cells, the lower housing part enclosing an interior space, and a housing cover, which can be connected or is connected to the lower housing part in such a way that the interior space is sealed off and closed off from an external environment. The lower housing part has a base element, a multiplicity of projections being arranged in a pattern on at least one area of the base element.

The advantages of the invention are obvious. The arrangement of a multiplicity of projections in at least one area of the base element in a pattern ensures that the roughness of the base element is increased on a macroscopic level. An increase in the roughness of the base element leads to the surface of the base element being enlarged. Such a surface enlargement has a positive effect on the vibration resistance of the truck battery thereafter and especially when the battery housing is used in a truck battery, since, by providing or arranging the multiplicity of projections in a pattern, the bonding between an adhesive which connects the multiplicity of electrochemical cells to the lower housing part and in particular to the base element of the lower housing part can be improved. In this way, the adhesive can advantageously be prevented from becoming detached from the base element, which can improve the service life and safety of the battery.

Since the multiplicity of projections can be easily formed by means of an injection-molding process when the battery housing is being produced, production costs and times can thus be advantageously reduced. Conventional already manufactured battery housings can also be retrofitted with a multiplicity of projections in at least one area by means of a hot-embossing or hot-stamping process that can be carried out easily and inexpensively.

According to a further aspect, the multiplicity of projections can increase the surface of the at least one area of the base element by at least 20%, preferably by at least 25%, particularly preferably by at least 30%, specifically in comparison with the surface of the at least one area of the base element without projections (i.e. the at least substantially flat surface of the at least one area of the base element).

Thus, the adhesive surface area can be increased by at least 20% in comparison with a conventional battery housing, which improves the vibration resistance and the bonding capability of the battery housing according to the invention, specifically without requiring a larger installation space and/or more expensive adhesive.

According to a further aspect, the multiplicity of projections may extend at least substantially perpendicularly from the base element in the direction of the interior space. An increase in the surface area of the base element can thus be achieved.

According to another aspect, the multiplicity of projections may be arranged in a strip pattern. At least some of the strips may extend along the longitudinal direction of the battery housing and/or at least some of the strips may extend along a width direction of the battery housing and/or diagonally to the longitudinal direction and/or width direction of the battery housing. This corresponds to patterns that are simple and thus, advantageously, inexpensive and not complicated to manufacture.

According to a further aspect, the pattern may correspond at least substantially to a waffle-like pattern. The projections include at least substantially diamond-shaped recesses into which adhesive can flow. An effect similar to a form fit can thus also be advantageously achieved, which improves the vibration resistance of the battery housing and thus of the battery when the battery housing is inserted.

According to a further aspect, the lower housing part may have a multiplicity of side walls, in particular four, which delimit the interior space and which are connected to the base element and extend at least substantially perpendicularly from the base element, which advantageously increases the surface of the base element in the direction of the interior space.

According to a further aspect, the lower housing part may also have a multiplicity of partition walls, which divide the interior space into a multiplicity of cell chambers. Each cell chamber is designed to receive an associated electrochemical cell.

According to a further aspect, the at least one area may be arranged at a distance from the side walls and/or the partition walls, so that a gap is arranged between the multiplicity of projections and the side walls or the partition walls. In particular, the gap may be formed circumferentially around the multiplicity of projections. As a result, it can advantageously be prevented that forces and/or vibrations which act on the base element are transmitted to the side walls, which can lead to the formation of cracks.

According to a further aspect, the at least one area may correspond to the entire surface area of the base element in the direction of the interior space, or may correspond to a surface area of the base element in a cell chamber, which is advantageously accompanied by an improved surface enlargement or increased roughness of the base element. As a result, the bonding effect of the adhesive on the base element can be improved in an inexpensive manner.

According to a further aspect, a cross section of the multiplicity of projections may be formed as at least substantially triangular, semicircular, rectangular or in the form of a sawtooth profile.

According to a further aspect, the surface of the multiplicity of projections may be roughened (for example on a microscopic level), which can advantageously lead to a further increase in the surface.

The object on which the invention is based is also achieved by a battery for a vehicle, in particular a battery for a truck, according to the subject matter of claim 16, the battery having the following: a battery housing, as described above, and a multiplicity of electrochemical cells, the multiplicity of electrochemical cells being arranged in the interior space of the lower housing part and connected to the base element in a material-bonding manner by means of an adhesive which is arranged on the base element of the lower housing part. By means of such an arrangement, a battery or a truck battery which is advantageously formed as vibration-resistant can be advantageously provided. In particular, as a result of the multiplicity of projections, the bonding effect of the adhesive on the base element of the lower housing part can be improved.

According to a further aspect, the adhesive may be a hot-melt adhesive or an epoxy-resin adhesive.

According to a further aspect, the multiplicity of projections can increase the surface of the at least one area of the base element by at least 20%, preferably by at least 25%, particularly preferably by at least 30%, in such a way that the adhesive surface area increases by at least 20%, preferably by at least 25%, particularly preferably by at least 30%. As a result, detachment of the adhesive or the adhesive layer from the base element can be advantageously prevented.

The invention will be discussed in more detail below, also with regard to further features and advantages, on the basis of the description of embodiments with reference to the appended drawings.

In the drawings:

FIG. 1 shows a schematic representation of a battery;

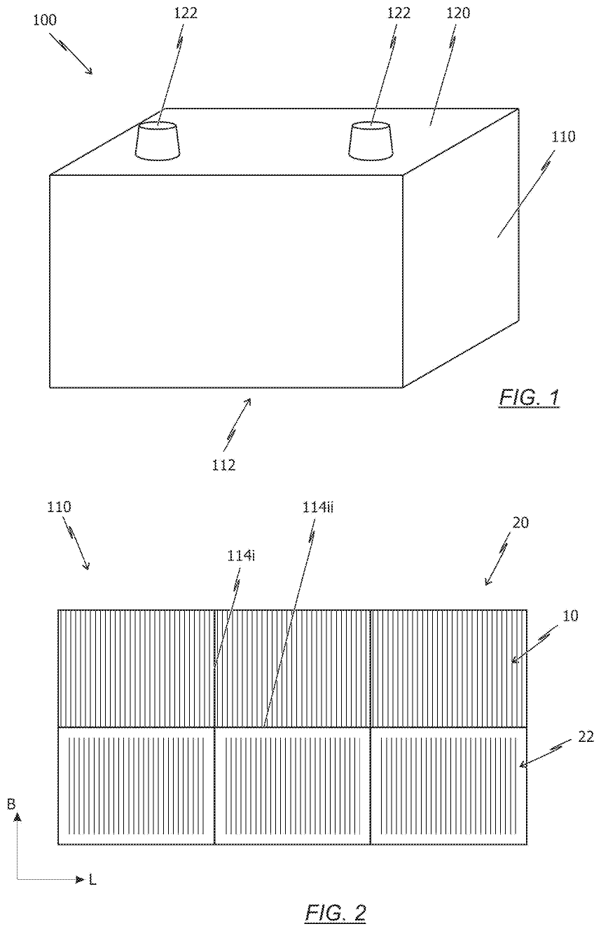

FIGS. 2 to 8 show schematic representations of a plan view of a lower housing part of the battery; and

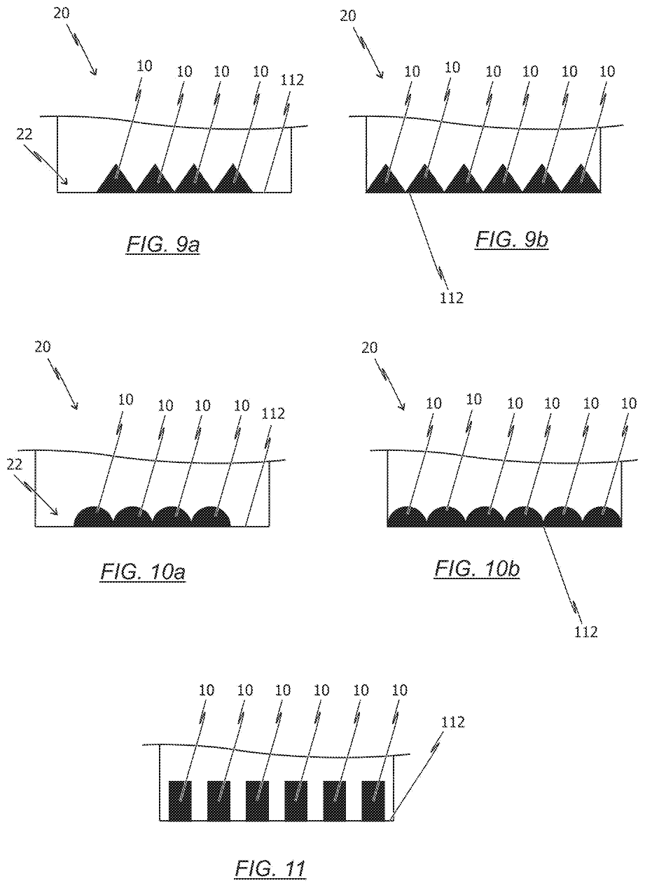

FIGS. 9a to 11 show schematic representations of a cross section through a cell chamber in the battery housing.

Aspects of the battery housing according to the invention and the battery according to the invention are described in more detail below with reference to the representations in FIGS. 1 to 11. Elements and functions that are the same or have the same effect are provided with the same or similar reference signs.

In each of the drawings, the dimensional relationships in the figures and/or the number of elements shown does not necessarily coincide with the actual dimensional relationships or the actual number of elements shown. The dimensional relationships between the figures also do not necessarily have to coincide.

In the following, the battery and the battery housing are described in such a way that relative terms refer to the installed state of the battery. For example, “in an upper area” means in an upper area as seen in the installed state, “in a lateral area” means in an area which is located in a front, rear, left-hand or right-hand area as seen in the installed state and in a direction of travel, and “in a lower area” means in a lower area as seen in the installed state.

Batteries which are provided with a battery housing according to the present invention are used in particular as starter batteries in vehicles. The battery may be arranged in a front area of the vehicle as seen in the direction of travel, in a rear area of the vehicle and/or in an area below the seats, in particular below the driver's seat.

The vehicle may be an aircraft or watercraft, a track-guided vehicle, an off-road vehicle or, preferably, a road vehicle, whereby a road vehicle can be understood to be a passenger car, in particular a truck, a bus or a mobile home.

If the battery is used in a truck, it is also conceivable that it is arranged at a location outside the driver's cab, and in particular may be attached to a fifthwheel pick-up plate of the truck.

The battery described below is based on lead-acid technology. However, it is also conceivable that the battery is based on other technologies, such as NIMH, lithium-ion or nickel-cadmium technology.

Batteries based on lead-acid technology are particularly suitable for use as starter batteries in vehicles. Furthermore, such batteries can likewise be used wherever relatively high currents are required in a short period of time.

The battery for a vehicle or the battery for a truck according to the present invention has a battery housing 100 and a multiplicity of electrochemical cells, which are arranged and received in the battery housing 100.

The battery housing 100 may be divided into a lower housing part 110 and a housing cover 120, which can be connected to one another in such a way that an interior space defined and enclosed by the battery housing 100 is closed off and sealed off from an external environment. In particular, the housing cover 120 may be welded to the lower housing part 110. Alternatively, it is also conceivable to tightly connect the housing cover 120 to the lower housing part 110 and close them off by means of one or more screw connections and/or clamping elements.

At least one positive and one negative battery terminal 122, which are electrically connected to the multiplicity of electrochemical cells, may be arranged or inserted in the housing cover 120. Furthermore, a degassing opening, which can be closed off or is closed off with a degassing plug, and/or a filling opening, which can be closed off or is closed off with a closing plug, may be arranged in the housing cover 120.

The lower housing part 110 is formed in such a way that it receives a multiplicity of electrochemical cells and at least substantially defines or encloses the interior space of the battery housing 100. For this purpose, the lower housing part has a multiplicity of side walls, in particular four, which delimit (in particular enclose) the interior space and which are connected to a base element 112. In particular, the multiplicity of side walls extend substantially perpendicularly from the base element 112, so that the interior space is at least substantially defined by the multiplicity of side walls and the base element 112.

The base element 112 and the side walls may be formed integrally, which is advantageously easy and inexpensive to manufacture (for example by an injection-molding process). However, it is equally also conceivable to form the base element 112 as an insert which can be cast into the side walls, as a result of which the material of the base element 112 can advantageously be selected independently of the material of the side walls.

Advantageously, for example, depending on the type of adhesive that is to be used, the material of the insert may be selected in such a way that a bonding effect of the adhesive on the insert or the base element that is as optimum as possible can be achieved.

Furthermore, a multiplicity of partition walls 114i, 114ii, which divide the interior space into a multiplicity of cell chambers 20, may be arranged in the lower housing part 110.

In particular, a longitudinal partition wall 114ii arranged along a longitudinal direction L of the battery or battery housing 100 and/or one or more transverse partition wall 114i or partition walls 114i arranged parallel to one another in width direction B of the battery or battery housing 100 may be arranged.

For example, as indicated in the schematic representations in FIGS. 2 to 8, the interior space of the lower housing part 110 may be divided by means of a longitudinal partition 114ii and two transverse partition walls 114i spaced apart from one another at an equal distance into six cell chambers 20 of at least substantially the same size.

Although this is not explicitly shown in the figures, it is of course also conceivable that, depending on the requirement and the required number of electrochemical cells, the battery housing 100 or the lower housing part 110 has more or fewer than six cell chambers 20.

It is also conceivable that the partition walls 114i, 114ii have a length which at least substantially corresponds to the width of the battery housing 100 or the length of the battery housing. However, it is equally also conceivable that the length of the partition walls 114i, 114ii is formed in such a way that it corresponds to the width or length of a cell chamber. In other words, the lower housing part 110 indicated in FIG. 2 may be divided either by means of a (large) longitudinal partition wall 114ii and two transverse partition walls 114i which are spaced apart from one another in the longitudinal direction L. Equally well, however, three longitudinal partition walls 114ii and four transverse partition walls 114i spaced apart from one another could be arranged. In both cases, for example six cell chambers 20 of at least substantially the same size can be defined.

The lower housing part 110 is also designed to receive a multiplicity of electrochemical cells and to arrange them therein. In particular, in each case an electrochemical cell may be received in an associated cell chamber 20 and arranged therein.

Each of the electrochemical cells has a cell stack which is formed from a multiplicity of positive electrode plates and negative electrode plates, as well as a multiplicity of separators, which electrically isolate the positive electrode plates from the negative electrode plates. In this connection, for example, each separator may be formed as a separator pocket, in each of which a positive electrode plate is received.

Furthermore, if the battery is formed as an AGM battery (absorbent glass mat battery), a multiplicity of fiberglass or fleece mats, in which the battery acid is completely absorbed, may be arranged. This means that the battery can be operated dry and in any position. However, it is equally conceivable to provide or form a wet battery with a liquid electrolyte.

Optionally, the cell stacks may also be arranged in an additional cell housing.

In order to increase the vibration resistance of the battery, the cell stacks or the cell housing are connected to the base element 112 in a material-bonding manner. In particular, the cell stacks are bonded onto the base element 112.

A hot-melt adhesive, a two-component adhesive or an adhesive based on epoxy resin is suitable for example as the adhesive.

The battery housing 100 (i.e. lower housing part 110 and/or housing cover 120) may in particular be made of a polyolefin or a copolymer which comprises a polyolefin. In particular, the battery housing 100 may be made of polypropylene, polyethylene, polypropylene-polyethylene copolymer, and the like.

In order to prevent the material-bonding connection between the cell stack or the cell housing and the base element 112 from loosening due to vibrations and forces during operation, a multiplicity of projections 10 that can improve the vibration resistance of the battery are arranged on the surface area of the base element 112 facing the interior space of the battery housing 100.

The multiplicity of projections 10 are arranged in a pattern at least on an area of the base element 112. In other words, at least in a plan view (i.e. a plane defined by the longitudinal direction L and width direction B of the battery housing 100) of the base element 112, the multiplicity of projections 10 forms a pattern in at least one area.

FIGS. 2 to 8 each show an exemplary lower housing part 110, which has partition walls 114i, 114ii which divide the interior space of the battery housing 100 into six cell chambers 20 of at least substantially the same size.

Although not explicitly shown in the figures, it is of course also alternatively conceivable that no partition walls 114i, 114ii are provided, or a different number of partition walls 114i, 114ii, which divide the interior space of the battery housing 100 into a different number of cell chambers 20. For example, an area in which the multiplicity of projections 10 are arranged may be formed in such a way that it extends at least substantially over the entire surface area of the base element 112.

Also in FIGS. 2 to 8, the three upper cell chambers 20 seen in the width direction B are formed without a gap 22 and the three lower cell chambers 20 seen in the width direction B are formed with a gap 22. However, this is only an exemplary representation and can be chosen as desired, depending on the requirements. For example, it may be that none of the cell chambers 20 have a gap 22 (i.e. the multiplicity of projections 10 extend in all of the cell chambers 20 or in the interior space up to the respective side walls or partition walls 114i, 114ii) or all of the cell chambers 20 are formed in such a way that a gap 22 is formed between the respective cell walls or partition walls 114i, 114ii and the multiplicity of projections 10 (i.e. the projections 10 do not extend up to the partition wall 114i, 114ii or side wall of the battery housing 100). In particular, the gap 22 may be formed circumferentially around the multiplicity of projections 10.

It is also conceivable that—unlike as shown in FIGS. 2 to 8—either all of the areas are arranged with a gap 22 to the side walls or partition walls 114i, 114ii or all of the projections 10 extend up to the partition walls 114i, 114ii or side walls (i.e. without a gap 22).

As indicated in FIG. 2 by way of example, the pattern may take the form of a strip pattern. As shown in FIG. 2, the multiplicity of projections 10 extend parallel to one another and in the width direction B of the battery housing 100.

As indicated in FIG. 2, a multiplicity of projections are arranged in six areas, which at least substantially correspond to the surface area of the base element 112 in a corresponding cell chamber 20.

The multiplicity of projections may extend from the partition wall 114ii up to a side wall of the lower housing part 110, as is indicated for example in the upper three cell chambers 20.

However, it is equally conceivable, as indicated in the lower three cell chambers 20 of FIG. 2, that the multiplicity of projections 10 are set at a distance from the side walls or partition walls 114i, 114ii by a gap 22.

In particular, a gap 22 between the multiplicity of projections 10 and the corresponding side walls or partition walls 114i, 114ii can advantageously ensure that forces and vibrations that act on the base element 112 are not so easily transmitted to the side walls or partition walls 114i, 114ii, as a result of which the risk of crack formation in the side walls or partition walls 114i, 114ii and/or the transition area from the base element 112 to the side walls or partition walls 114i, 114ii can be reduced.

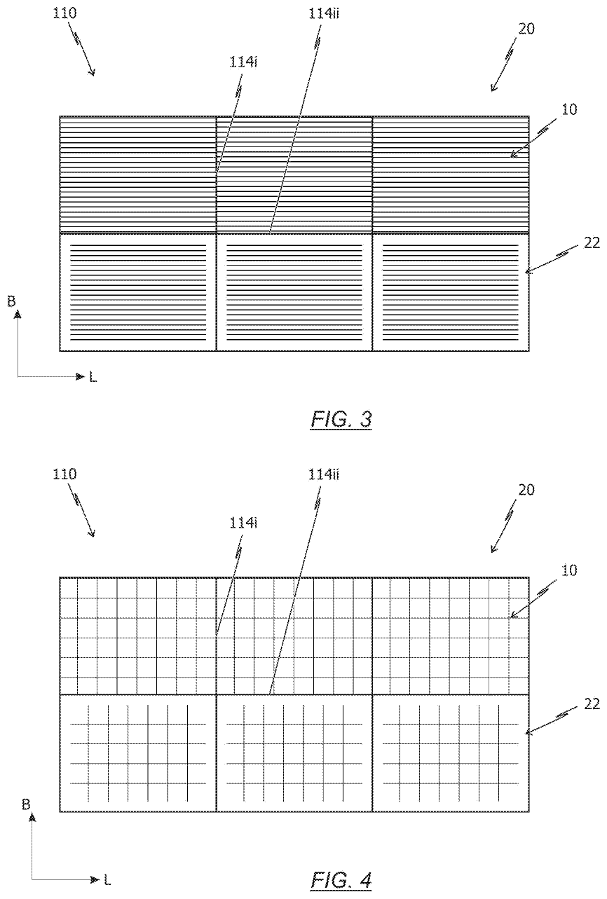

FIG. 3 shows a further embodiment of the pattern in which the multiplicity of projections 10 may be arranged. In particular, the projections 10 may be arranged in a longitudinal strip pattern, so that the multiplicity of projections 10 extend substantially along the longitudinal direction L of the battery housing 100 and parallel to one another. As already described above, the multiplicity of projections 10 may either extend completely up to the side walls or partition walls 114ii, or a gap 22 may be formed between the side walls or partition walls 114i, 114ii and the multiplicity of projections 10.

FIG. 4 shows another pattern, in which a multiplicity of projections are arranged in a checkered pattern. The distances between the projections 10 may be chosen to be greater than in the case of a pure strip pattern, in order to ensure that the adhesive can flow into the depressions enclosed by the projections. Just as with respect to FIG. 2 and FIG. 3, in the case of the pattern according to FIG. 4 a gap 22 may be provided or arranged between the multiplicity of projections 10 and the corresponding partition walls 114i, 114ii or side walls.

FIG. 5 shows an embodiment in which the multiplicity of projections 10 extend diagonally, i.e. at an angle (which is not perpendicular) to the longitudinal direction L or width direction B.

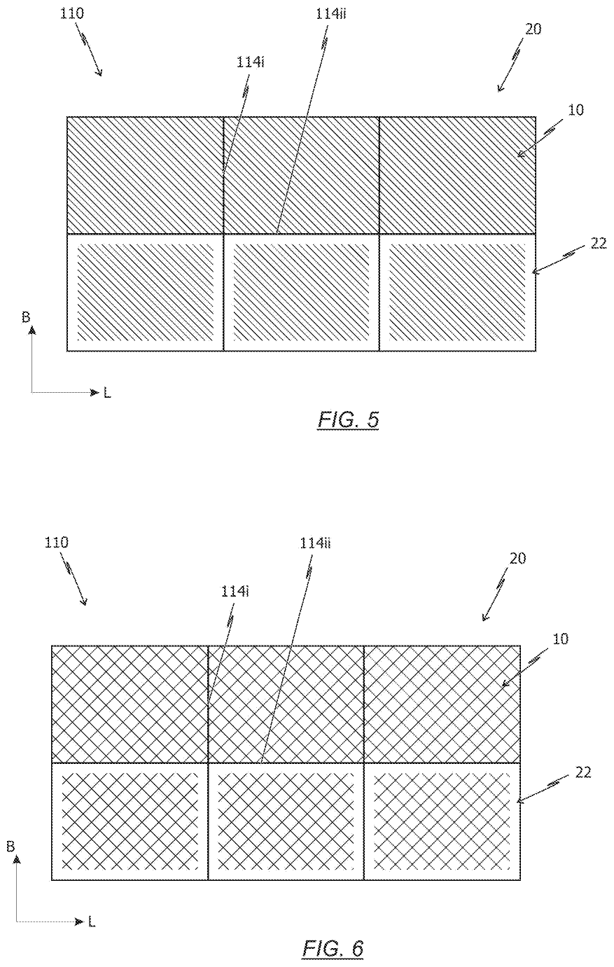

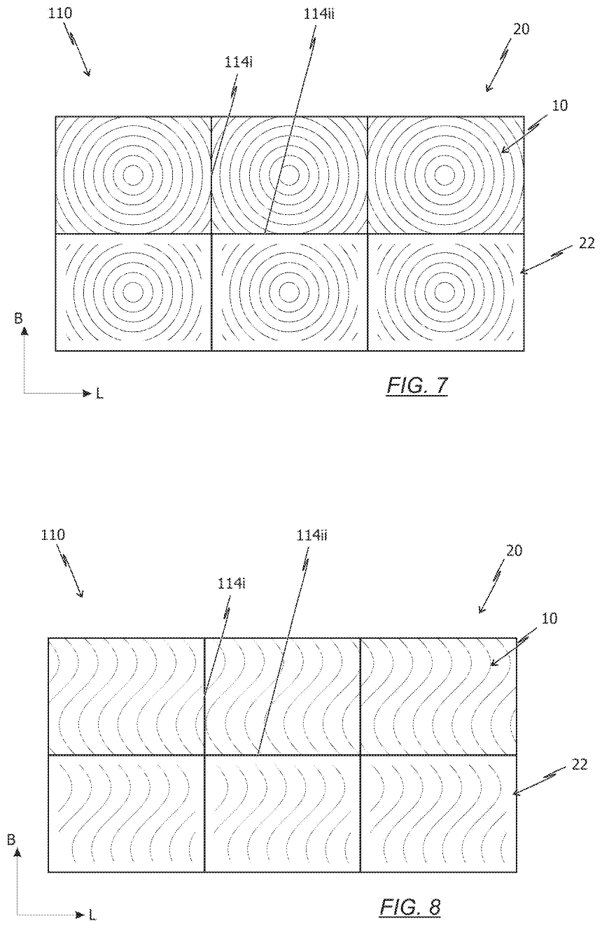

The pattern may equally well be, as indicated in FIG. 6, a waffle-like pattern or, as indicated in FIG. 7, a pattern in which the multiplicity of projections 10 extend at least substantially circularly and/or partially circularly from a central region of the at least one area, or the pattern may be formed in a substantially serpentine-shaped manner, as indicated in FIG. 8.

However, other patterns, such as for example a regular or irregular zigzag shape, of the projections 10 are also conceivable.

Even if it is not explicitly shown in the figures, it should be noted that the shape of the pattern is not limited to the patterns described above.

Even if it is not explicitly shown in the figures, different areas may have different patterns. It is also conceivable to form different patterns of projections 10 in one area.

In particular, the intended aim is that, by means of the multiplicity of projections 10, the surface of the base element 112 is enlarged and thus the roughness of the base element 112 increases, as a result of which a better adhesive effect can be achieved.

This can ensure that, even if vibrations occur during operation of the battery, the adhesive specifically does not become detached from the base element 112, which can lead to damage to the electrochemical cells and/or the battery housing 100.

It may therefore be advantageous if at least 5 projections 10, in particular at least 10 projections 10, in particular at least 20 projections 10, are arranged in a corresponding area. Different areas may have a different number of projections 10. The larger the area (or the surface of the area) on which the multiplicity of projections 10 are formed, the more projections 10 (depending on their orientation) can tend to be arranged.

The arrangement of at least one area with a multiplicity of projections 10 arranged in a pattern can reduce the surface of the corresponding area of the base element 112 by at least 25%, in particular at least 30%, in particular at least 40%, of the surface area of the corresponding area of the base element 112 without projections 10, which also increases the adhesive surface area. This significantly increases the adhesive strength and thus also the resistance to vibrations of the battery.

Although it is not explicitly shown in the figures, it is conceivable that at least one projection 10 of the multiplicity of projections 10 has a multiplicity of notches along the direction of extent of the projection 10, in such a way that the projection 10 at least substantially has a peak/valley profile along its direction of extent. As a result, the surface can advantageously be enlarged further and, at the same time, a form fit can be formed between the surface of the base element 112 and the adhesive.

The projections 10 may have a cross-sectional shape as shown or indicated for example in FIGS. 9a, 9b, 10a, 10b and 11. The term cross section refers to a section through the multiplicity of projections 10 perpendicular to their direction of extent. For example, FIG. 3 shows a section parallel to the width direction B and seen along the longitudinal direction L through the multiplicity of projections 10.

The term “cross-sectional shape” is understood in this connection to mean the outline of a projection 10 which is formed in the direction of extent onto the (vertical) section of the projection 10.

This outline may in particular be triangular, with the individual projections being able to be arranged directly adjacent to one another, as indicated for example in FIGS. 9a and 9b.

However, it is equally conceivable to arrange the individual projections 10 at a distance from one another, as a result of which the distribution of the adhesive between the projections 10 can be facilitated. It is also conceivable to arrange the projections 10 at non-uniform distances from one another. For example, smaller distances between the projections 10 may be formed in areas close to the partition walls 114i, 114ii or side walls, in order to counteract a shear effect in peripheral areas (or more stressed areas), and larger distances between the projections 10 may be formed in a central area (or less stressed area).

Another possible cross-sectional shape of the projections 10, not shown in the figures, is for example also a sawtooth profile, which corresponds to a special shape of the triangular profile in which the cross section for example rises obliquely on the left side and runs straight down on the right side (perpendicular to the base element 112), that is to say an asymmetrical triangle.

Furthermore, as indicated in FIGS. 10a and 10b, the projections 10 may also have a semicircular shape. In this case, the cell stacks can for example be aligned and arranged more easily.

The projections 10 according to FIGS. 10a and 10b may also be arranged at a distance from one another, even if this is not explicitly shown in the figures.

Alternatively, it is also conceivable that the projections 10 may have a substantially rectangular cross section, as indicated in FIG. 11.

In summary, various areas in which a multiplicity of projections 10 can be arranged in various of the patterns and cross-sectional shapes described above may be formed on the base element 112. It is also conceivable to provide or arrange different patterns in different cross-sectional shapes in one area (for example on a surface area of the base element 112 which is assigned to a cell chamber 20).

The height of the projections 10 can be a maximum of 5 mm, in particular a maximum of 3 mm, particularly preferably a maximum of 2 mm, in order not to unnecessarily restrict or reduce the available interior space.

Thus, all of the patterns and cross-sectional shapes described above can be freely combined with one another and are not limited to the embodiments shown in the figures.

The embodiments described above have been described in such a way that the surface area of the base element 112 is enlarged as a result of a multiplicity of projections 10. However, it is equally conceivable to arrange a multiplicity of recesses in a pattern instead of the projections 10 (i.e. a case of being formed in complementary manner). A combination of projections and recesses is also conceivable.

The multiplicity of projections 10 can be introduced into the base element 112 easily and inexpensively by means of an injection-molding process during the manufacture of the battery housing 100 or the lower housing part 110. However, it is also conceivable to retrofit battery housings 100 that have already been manufactured and to provide them with a multiplicity of projections 10 by means of a hot-embossing process or hot-stamping process. A multiplicity of projections 10 can thus be arranged in an easy and inexpensive manner.

Alternatively, it could also be conceivable to form the projections 10 from open-pored foam, so that the adhesive can flow into the open pores. In addition, by means of such an embodiment, a certain elasticity and damping capacity could be introduced into the base element 112, which can have the effect that forces and/or vibrations which arise during operation of the battery and act on the battery housing 100 can be at least partially absorbed and damped. This could advantageously improve the safety of the battery.

It is also conceivable that the surface of the multiplicity of projections 10 is additionally roughened further (on a microscopic level), as a result of which a further surface enlargement can be achieved, which leads to an enlarged adhesive surface area.

Briefly summarized, it is intended that at least such a multiplicity of projections 10 should be arranged on the base element 112 in at least one area that an enlargement of the adhesive surface area of the at least one area by at least 20%, in particular at least 30%, preferably at least 40%, can be achieved.

At this point it should be noted that all of the parts described above, considered individually or in any combination, in particular the details shown in the drawings, are claimed as being essential to the invention. Amendments thereto are familiar to a person skilled in the art.

### LIST OF DESIGNATIONS

10 Projection/projections
20 Cell chamber
22 Gap
100 Battery housing
110 Lower housing part
112 Base element
114i, 114ii Partition walls
120 Housing cover
122 Battery terminal
B Width direction
L Longitudinal direction

1. A battery housing for a vehicle battery, in particular for a truck battery, the battery housing having the following:
a lower housing part for receiving a multiplicity of electrochemical cells, the lower housing part enclosing an interior space; and
a housing cover, which can be connected or is connected to the lower housing part in such a way that the interior space is sealed off and closed off from an external environment,
wherein the lower housing part has a base element, and wherein a multiplicity of projections are arranged in a pattern on at least one area of the base element.

2. The battery housing as claimed in claim 1,
wherein the multiplicity of projections increase the surface area of the at least one area of the base element by at least 20%, preferably by at least 25%, particularly preferably by at least 30%.

3. The battery housing as claimed in claim 1,
wherein the multiplicity of projections extends at least substantially perpendicularly from the base element in the direction of the interior space.

4. The battery housing as claimed in claim 1, wherein the multiplicity of projections are arranged in a strip pattern.

5. The battery housing as claimed in claim 4,
wherein at least some of the strips extend along the longitudinal direction (L) of the battery housing.

6. The battery housing as claimed in claim 4, wherein at least some of the strips extend along a width direction (B) of the battery housing.

7. The battery housing as claimed in claim 4,
wherein the strips extend diagonally to a longitudinal direction (L) of the battery housing.

8. The battery housing as claimed in claim 1, wherein the pattern corresponds at least substantially to a waffle-like pattern.

9. The battery housing as claimed in claim 1, wherein the pattern has concentric circles or concentric partial circles.

10. The battery housing as claimed in claim 1, wherein the lower housing part has a multiplicity of side walls, in particular four, which delimit the interior space and which are connected to the base element and extend at least substantially perpendicularly from the base element.

11. The battery housing as claimed in claim 10, wherein the lower housing part has a multiplicity of partition walls, which divide the interior space into a multiplicity of cell chambers.

12. The battery housing as claimed in claim 10, wherein the at least one area is arranged at a distance from the side walls and/or the partition walls, so that a gap is arranged between the multiplicity of projections and the side walls or the partition walls.

13. The battery housing as claimed in claim 1, wherein the at least one area corresponds to the entire surface area of the base element in the direction of the interior space, or in particular in combination with claim 11, wherein the at least one area corresponds to a surface area of the base element in a cell chamber.

14. The battery housing as claimed in claim 1, wherein a cross section of the multiplicity of projections is at least substantially triangular, semicircular or rectangular.

15. The battery housing as claimed in claim 1, wherein the surface of the multiplicity of projections is roughened.

16. A battery for a vehicle, in particular a battery for a truck, the battery having the following:
a battery housing as claimed in one of the preceding claims;
a multiplicity of electrochemical cells,
wherein the multiplicity of electrochemical cells are arranged in the interior space of the lower housing part and are connected to the base element in a material-bonding manner by means of an adhesive which is arranged on the base element of the lower housing part.

17. The battery as claimed in claim 16,
wherein the adhesive is a hot-melt adhesive or an epoxy-resin adhesive.

18. The battery as claimed in claim 16,
wherein the multiplicity of projections increase the surface of the at least one area of the base element by at least 20%, preferably by at least 25%, particularly preferably by at least 30%, in in such a way that the adhesive surface area increases by at least 20%, preferably by at least 25%, particularly preferably by at least 30%.
